(19) United States
(12) Patent Application Publication
(10) Pub. No.: US 2024/0129616 A1
(43) Pub. Date: Apr. 18, 2024

(54) REALITY CAPTURE USING CLOUD BASED COMPUTER NETWORKS

(71) Applicant: FARO Technologies, Inc., Lake Mary, FL (US)

(72) Inventors: Denis WOHLFELD, Ludwigsburg (DE); Steffen KAPPES, Oedheim-Degmarn (DE)

(21) Appl. No.: 18/364,717

(22) Filed: Aug. 3, 2023

Related U.S. Application Data
(60) Provisional application No. 63/415,830, filed on Oct. 13, 2022.

(51) Int. Cl. H04N 23/62; H04N 23/60; H04N 23/698

(52) U.S. Cl. CPC H04N 23/62; H04N 23/64; H04N 23/698

(57) ABSTRACT

Reality capture using cloud based computer networks is provided. Techniques include receiving user input of an object to capture, the user input including a location, an accuracy category, and a size category of the object, and generating at least one option to capture the object, in response to user input. Techniques include responsive to a user selecting the at least one option to capture the object, configuring a plurality of drones with a first setting for capturing at least a first portion of the object, and configuring a scanner with a second setting for capturing at least a second portion of the object. Techniques include causing the plurality of drones to capture the first portion of the object, in response to the drones being initiated at the location and causing the scanner to capture the second portion of the object, in response to the scanner being initiated at the location.

### CROSS-REFERENCE TO RELATED APPLICATIONS

This application claims the benefit of U.S. Provisional Patent Application Ser. No. 63/415,830, filed Oct. 13, 2022, and entitled “REALITY CAPTURE USING CLOUD BASED COMPUTER NETWORKS,” the contents of which are incorporated by reference herein in their entirety.

### BACKGROUND

The one or more embodiments described herein relates generally to reality capture using cloud based computer networks, and more specifically, to reality capture with automatic setup and capture by devices.

The points in a three-dimensional (3D) point cloud, such as that generated by a 3D laser scanner time-of-flight (TOF) coordinate measurement device or created by algorithms that takes data from photogrammetry, are very useful. A 3D TOF laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A TOF laser scanner is a scanner in which the distance to a target point is determined based on the speed of light in air between the scanner and a target point. Laser scanners are typically used for scanning closed or open spaces such as interior areas of buildings, industrial installations and tunnels. They may be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Generating an image requires at least three values for each data point. These three values may include the distance and two angles, or may be transformed values, such as the x, y, z coordinates. In an embodiment, an image is also based on a fourth gray-scale value, which is a value related to irradiance of scattered light returning to the scanner.

Most TOF scanners direct the beam of light within the measurement volume by steering the light with a beam steering mechanism. The beam steering mechanism includes a first motor that steers the beam of light about a first axis by a first angle that is measured by a first angular encoder (or other angle transducer). The beam steering mechanism also includes a second motor that steers the beam of light about a second axis by a second angle that is measured by a second angular encoder (or other angle transducer).

Many contemporary laser scanners include a camera mounted on the laser scanner for gathering camera digital images of the environment and for presenting the camera digital images to an operator of the laser scanner. By viewing the camera images, the operator of the scanner can determine the field of view of the measured volume and adjust settings on the laser scanner to measure over a larger or smaller region of space. In addition, the camera digital images may be transmitted to a processor to add color to the scanner image. To generate a color scanner image, at least three positional coordinates (such as x, y, z) and three color values (such as red, green, blue “RGB”) are collected for each data point.

A 3D point cloud of data points is formed by the set of three positional coordinates (such as x, y, z) and three color values (such as red, green, blue “RGB”). Processing is generally performed on the 3D point cloud of data points which can include millions of data points. However, additional software processing tools for 3D data points in a 3D point cloud can be helpful to a user.

Accordingly, while existing 3D scanners and existing processing for 3D point clouds are suitable for their intended purposes, what is needed is a reality capture process having certain features of embodiments disclosed herein.

### BRIEF DESCRIPTION

According to one embodiment, a computer-implemented method of reality capture using cloud based computer networks is provided. The method includes receiving, by a processor, user input of an object to capture, the user input including a location, an accuracy category, and a size category of the object. The method includes generating, by the processor, at least one option to capture the object, in response to the user input, and responsive to a user selecting the at least one option to capture the object, configuring, by the processor, a plurality of drones with a first setting for capturing at least a first portion of the object. The method includes configuring, by the processor, a scanner with a second setting for capturing at least a second portion of the object, and causing, by the processor, the plurality of drones to capture the first portion of the object, in response to the plurality of drones being initiated at the location. The method includes causing, by the processor, the scanner to capture the second portion of the object, in response to the scanner being initiated at the location.

In addition to one or more features described herein, or as an alternative, further embodiments of the method may include that generating the at least one option to capture the object comprises suggesting the plurality of drones based in part on the accuracy category associated with the first portion of the object.

In addition to one or more features described herein, or as an alternative, further embodiments of the method may include that generating the at least one option to capture the object comprises suggesting the plurality of drones based in part on a time requirement.

In addition to one or more features described herein, or as an alternative, further embodiments of the method may include that generating the at least one option to capture the object comprises suggesting the scanner based in part on the accuracy requirement associated with the second portion of the object.

In addition to one or more features described herein, or as an alternative, further embodiments of the method may include parsing one or more databases to obtain specifications or requirements associated with the location of the object.

In addition to one or more features described herein, or as an alternative, further embodiments of the method may include, in the first settings, restricting a height for flying the plurality of drones based on the specification or the requirements obtained from the one or more databases.

In addition to one or more features described herein, or as an alternative, further embodiments of the method may include, in the first settings, causing the plurality of drones to update a user device of the user during a time of the plurality of drones capturing the first portion of the object.

In addition to one or more features described herein, or as an alternative, further embodiments of the method may include that coverage of the first portion of the object overlaps coverage of the second portion of the object, such that registration is operable for outputs of the plurality of drones and the scanner.

In addition to one or more features described herein, or as an alternative, further embodiments of the method may include receiving a first output from the plurality of drones and a second output from the scanner via one or more communication links.

In addition to one or more features described herein, or as an alternative, further embodiments of the method may include providing an approximate time of completion for capturing the object using the at least one option.

According to another embodiment, a system is provided that includes a memory having computer readable instructions and one or more processors for executing the computer readable instructions, the computer readable instructions controlling the one or more processors to perform operations. The operations include receiving a user input of an object to capture, the user input including a location, an accuracy category, and a size category of the object. The operations further include generating at least one option to capture the object, in response to the user input. The operations further include, in response to a user selecting the at least one option to capture the object, configuring a plurality of drones with a first setting for capturing at least a first portion of the object. The operations further include configuring a scanner with a second setting for capturing at least a second portion of the object. The operations further include causing the plurality of drones to capture the first portion of the object, in response to the plurality of drones being initiated at the location. The operations further include causing the scanner to capture the second portion of the object, in response to the scanner being initiated at the location

In addition to one or more features described herein, or as an alternative, further embodiments of the system may include that generating the at least one option to capture the object comprises suggesting the plurality of drones or a handheld scanner based in part on the accuracy category associated with the first portion of the object.

In addition to one or more features described herein, or as an alternative, further embodiments of the system may include that generating the at least one option to capture the object comprises suggesting the plurality of drones based in part on a time requirement.

In addition to one or more features described herein, or as an alternative, further embodiments of the system may include that generating the at least one option to capture the object comprises suggesting the scanner based in part on the accuracy category associated with the second portion of the object.

In addition to one or more features described herein, or as an alternative, further embodiments of the system may include that the one or more processors are configured to parse one or more databases to obtain specifications or requirements associated with the location of the object.

In addition to one or more features described herein, or as an alternative, further embodiments of the system may include that, in the first setting, the one or more processors are configured to restrict a height for flying the plurality of drones based on the specifications or the requirements obtained from the one or more databases.

In addition to one or more features described herein, or as an alternative, further embodiments of the system may include that, in the first setting, the one or more processors are configured to cause the plurality of drones to update a user device of the user during a time of the plurality of drones capturing the first portion of the object.

In addition to one or more features described herein, or as an alternative, further embodiments of the system may include that coverage of the first portion of the object overlaps coverage of the second portion of the object, such that registration is operable for outputs of the plurality of drones and the scanner.

In addition to one or more features described herein, or as an alternative, further embodiments of the system may include that the one or more processors are configured to receive a first output from the plurality of drones and a second output from the scanner via one or more communication links.

In addition to one or more features described herein, or as an alternative, further embodiments of the system may include that the one or more processors are configured to provide an approximate time of completion for capturing the object using the at least one option.

Other embodiments of the present invention implement features of the above-described method in computer systems and computer program products.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of embodiments of the invention are apparent from the following detailed description taken in conjunction with the accompanying drawings in which:

FIG. 1 is a block diagram of an example drone in accordance with one or more embodiments;

FIG. 2A is a perspective view of a laser scanner in accordance with one or more embodiments;

FIG. 2B is a side view of the laser scanner illustrating a method of measurement in accordance with one or more embodiments;

FIG. 3 is a schematic illustration of the optical, mechanical, and electrical components of the laser scanner in accordance with one or more embodiments;

FIG. 4 illustrates a schematic illustration of the laser scanner of FIG. 2A in accordance with one or more embodiments;

FIG. 5 is a block diagram of an example computer system for use in accordance with one or more embodiments;

FIG. 6 is a block diagram of an example system for reality capture using cloud based computer networks in accordance with one or more embodiments;

FIG. 7 depicts a flowchart of a computer-implemented method for reality capture using cloud based computer networks in accordance with one or more embodiments;

FIG. 8 is a block diagram of an example object for capture having portions with different capture requirements in accordance with one or more embodiments;

FIG. 9 is a block diagram of an example graphical user input for user input in accordance with one or more embodiments; and

FIG. 10 is a flowchart of a computer-implemented method for reality capture using cloud based computer networks in accordance with one or more embodiments.

The detailed description explains embodiments of the invention, together with advantages and features, by way of example with reference to the drawings.

### DETAILED DESCRIPTION

One or more embodiments described herein relates to reality capture using cloud based computer networks, with automatic setup and capture using one or more devices. Unmanned autonomous vehicles, commonly referred to as “drones,” are quickly becoming adopted by professionals who need to capture images or measurements of an object. Users are often faced with the task to capture an image or a measurement of a certain object, which may include an area, with a desired accuracy and a certain subsequent data workflow. In prior art systems, all of this is performed manually by the user, and the result depends on the experience of the user. Any capturing method requires specific assistance. In particular, capturing of images or measurements in drone applications can be quite complicated.

Accordingly, one or more embodiments provide software, such as, for example, FARO® Sphere software, FARO® Zone 3D software, FARO® Zone 2D software, etc., configured to support the user from initially setting up a project in the cloud, performing reality capture using a device(s), processing data, and enabling workflows. As an example, techniques disclosed herein provide a method for a drone capture application, which reduces or minimizes the user's interaction with the system after receiving user input while increasing or maximizing the output quality. The system may use available FARO® Sphere data and external data as well as best practices. According to one or more embodiments, for a project that desires medium accuracy, the system may suggest capturing images or measurements of a building with a drone as being sufficient to fulfill requirements of the project. However, for a project where higher accuracy is desired, the system may indicate that the higher accuracy can only be met by a stationary laser scanner. There may be a project that has different accuracy requirements for different parts of the building. In such a case, the system is configured to suggest both the drone(s) and a stationary laser scanner for capturing the different parts of the building according to accuracy requirements or even time restrictions. In this case, the system is designed to automatically configure one or more settings of the drone(s) and the stationary laser scanner to capture the building for the user, to a least meeting the requirements input by the user. The system can use the output of the drones and the stationary laser scanner to generate 2D images, 3D images, 3D point clouds, etc.

Technical effects and benefits of one or more embodiments include the efficient and automatic digital reproduction of objects, such as building, etc., using the efficient capturing methods, for examples, using drones, a stationary laser scanner, a handheld scanner, and/or a combination of any of the devices, without the user having significant experience in using the various capturing device/methods. This results in a recreation of the object, which may be a 3D point cloud or 3D images, 2D images, a panoramic view, a 3D image from photogrammetry, etc. Further, one or more embodiments are configured to allow the objectives and parameters for a project to be met without the user understanding the particular details of the image capturing devices and with at least some device settings of the image capturing devices being preset based on the objectives and requirements for the project.

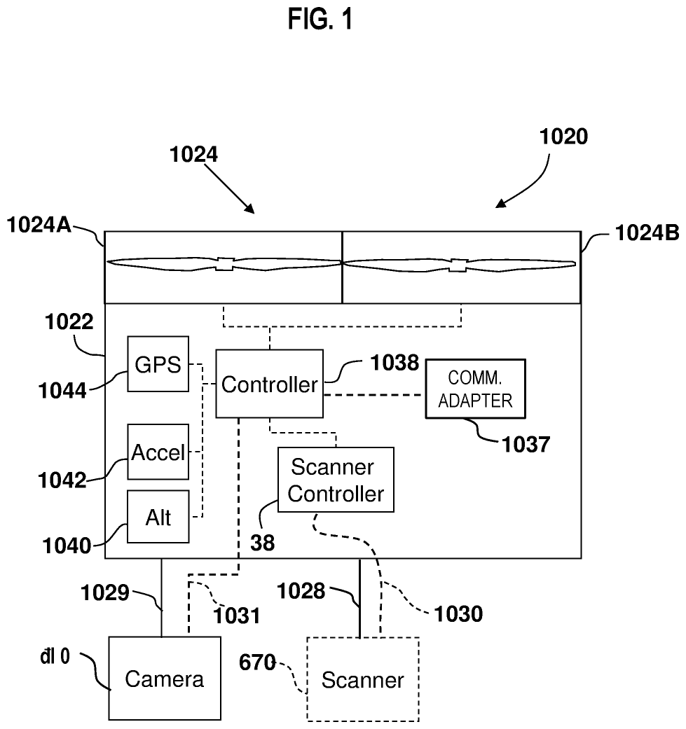

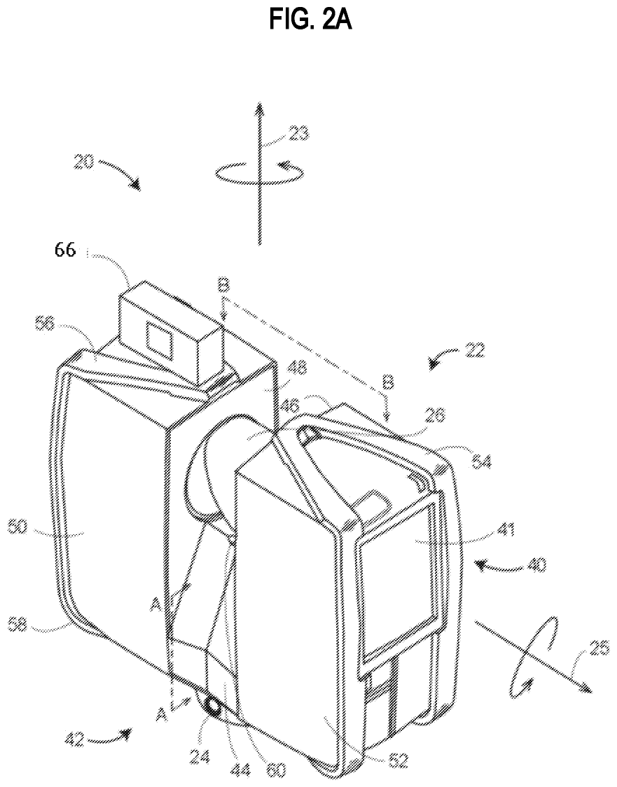

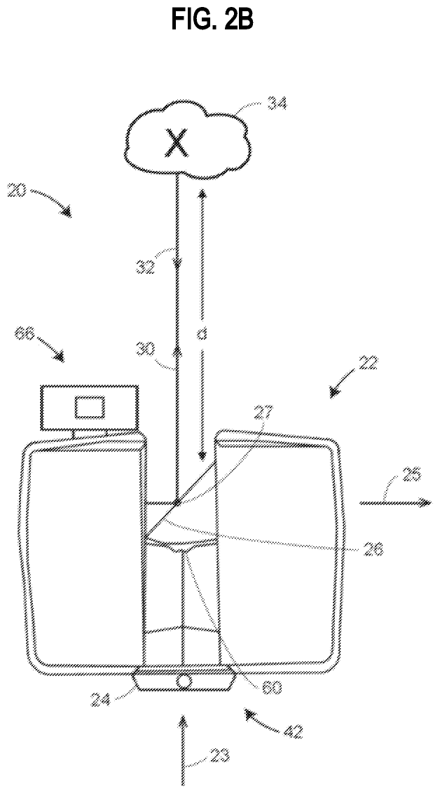

Referring now to FIG. 1, an example drone 1020 is depicted, which can be representative of numerous drones 1020. The drone 1020 can include a scanner 670 such as the laser scanner 20 as discussed in FIGS. 2A, 2B, 3, and 4 and/or another suitable three-dimensional coordinate scanning device. Similarly, the drone 1020 can include a camera 680, for example, having features of the cameras 66, 112 (of laser scanner 20 depicted in FIGS. 2A-4) and/or another suitable camera. The drone 1020 includes a fuselage 1022 that supports at least one thrust device 1024. In an embodiment, the drone 1020 includes a plurality of thrust devices 1024A, 1024B, such as four thrust devices arranged about the periphery of the fuselage 1022. In an embodiment, the thrust devices 1024 include a propeller member that rotates to produce thrust. The thrust devices 1024 may be configurable to provide both lift (vertical thrust) and lateral thrust (horizontal thrust). The vertical and horizontal components of the thrust allow the changing of the altitude, lateral movement, and orientation (attitude) of the drone 1020.

In the exemplary embodiment, the fuselage 1022 and thrust devices 1024 are sized and configured to carry a payload such as an optical scanner 670 that is configured to measure three-dimensional coordinates of points in the environment or on an object. Particularly, the drone 1020 can carry the camera 680 and/or the scanner 670. The scanner 670 may be a time-of-flight scanner, a triangulation scanner, an area scanner, a structured light scanner, or a laser tracker for example. In an embodiment, the scanner 670 may be releasably coupled to the fuselage 1022 by a coupling 1028. The camera 680 may be releasably coupled to the fuselage 1022 by a coupling 1029. Although it appears that the scanner 670 and camera 680 are coupled to the bottom of the fuselage 1022, it should be appreciated that that the scanner 670 and/or camera 680 can be mounted/installed around the done 1020 instead of the bottom.

In another embodiment, the scanner 670 may be integral with or fixedly coupled to the fuselage 1022. As will be discussed in more detail herein, the scanner 670 may also be coupled to a scanner controller 38 by a communication and power connection 1030. Similarly, the camera 680 may be coupled to the controller 1038 by a communication and power connection 1031. It should be appreciated that the scanner controller 38 may be located in the scanner 20, within the fuselage 1022, or include multiple processing units that are distributed between the scanner 20, the fuselage 1022, or are remotely located from the drone 1020. The scanner controller 38 may be coupled to communicate with a drone controller 1038.

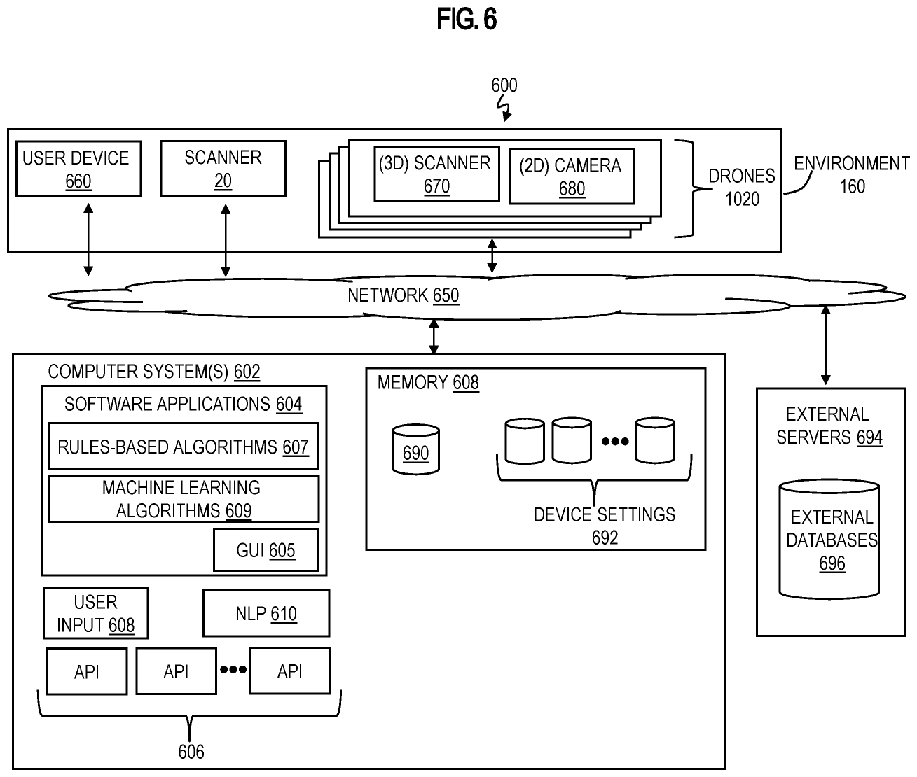

Both the drone controller 1038 and the scanner controller 38 may include processors that are responsive to operation control methods embodied in application code. These methods are embodied in computer instructions written to be executed by the processor, such as in the form of software. The controller 1038 is coupled to the thrust devices 1024 and configured to transmit and receive signals from the thrust devices 1024. The controller 1038 may further be coupled to one or more sensor devices that enable to the controller to determine the position, orientation, and altitude of the drone 1020. In an embodiment, these sensors may include an altimeter 1040, a gyroscope or accelerometers 1042 or a global positioning satellite (GPS) system 1044. In other embodiments, the controller 1038 may be coupled to other sensors, such as force sensors. The drone controller 1038 may be coupled to a communication adapter 1037 to transmit and receive signals from the computer system 602 over the network 650, such that the drone controller 1038 can execute instructions/commands from the computer system 602 as depicted in FIG. 6. Also, the drone controller 1038 can send images to the computer system 602.

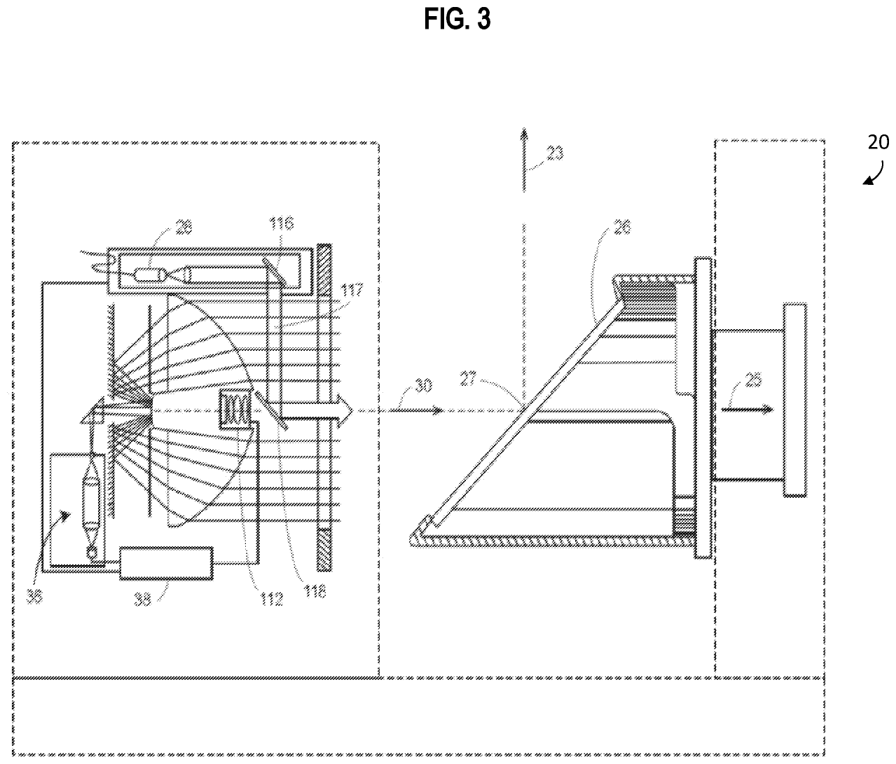

FIGS. 2A, 2B, and 3 depict a coordinate measurement device, such as a laser scanner 20 for optically scanning and measuring the environment surrounding the laser scanner 20. The laser scanner 20 has a measuring head 22 and a base 24. The measuring head 22 is mounted on the base 24 such that the laser scanner 20 may be rotated about a vertical axis 23. In one embodiment, the measuring head 22 includes a gimbal point 27 that is a center of rotation about the vertical axis 23 and a horizontal axis 25. The measuring head 22 has a rotary minor 26, which may be rotated about the horizontal axis 25. The rotation about the vertical axis may be about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary minor 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cair=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary minor 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the scanner 20 may also collect gray-scale information related to the received optical power (equivalent to the term “brightness.”) The gray-scale value may be determined at least in part, for example, by integration of the bandpass-filtered and amplified signal in the light receiver 36 over a measuring period attributed to the object point X.

The measuring head 22 may include a display device 40 integrated into the laser scanner 20. The display device 40 may include a graphical touch screen 41, as shown in FIG. 2A, which allows the operator to set the parameters or initiate the operation of the laser scanner 20. For example, the screen 41 may have a user interface that allows the operator to provide measurement instructions to the device, and the screen may also display measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 may be coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 may include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the minor 26 directs the emitted light beam 30 onto the traverse 44 and the prism 60. Due to non-linearities in the electronic components, for example in the light receiver 36, the measured distances d may depend on signal strength, which may be measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 may be used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 may be a device that captures and measures a parameter associated with the scanned area or the scanned object and provides a signal representing the measured quantities over an image acquisition area. The auxiliary image acquisition device 66 may be, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and may have the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 may be a near infrared laser light (for example, light at wavelengths of 780 nm or 1150 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 23 and by steering the mirror 26 about the axis 25.

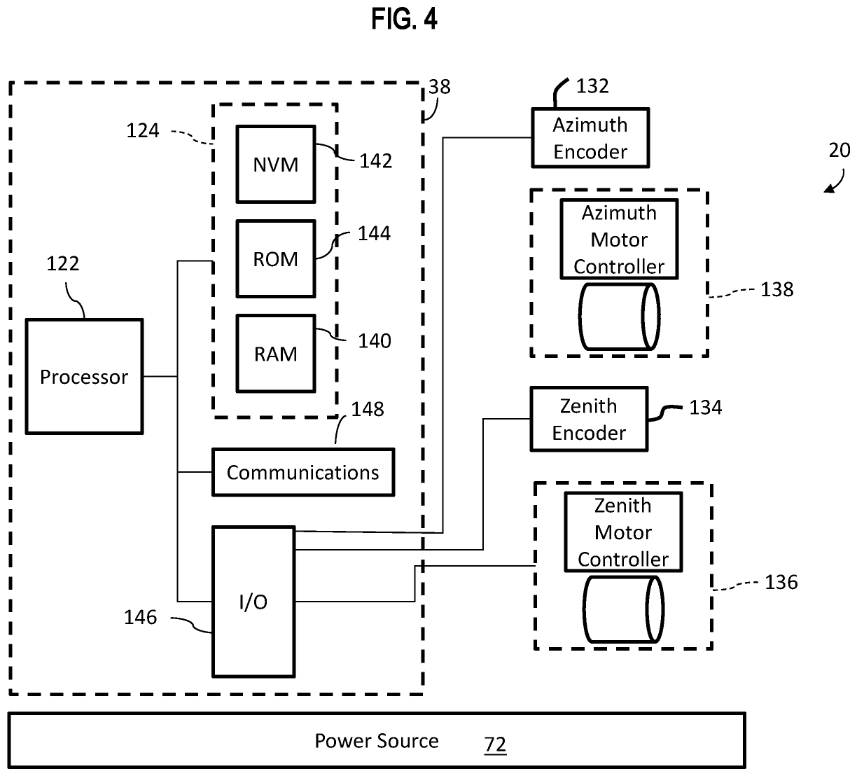

Referring now to FIG. 4 with continuing reference to FIGS. 2A-3, elements are shown of the laser scanner 20. Controller 38 is a suitable electronic device capable of accepting data and instructions, executing the instructions to process the data, and presenting the results. The controller 38 includes one or more processing elements 122. The processors may be microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 may be displayed on a user interface 40 coupled to controller 38. The user interface 40 may be one or more LEDs (light-emitting diodes), an LCD (liquid-crystal diode) display, a CRT (cathode ray tube) display, a touch-screen display or the like. A keypad may also be coupled to the user interface for providing data input to controller 38. In one embodiment, the user interface is arranged or executed on a mobile computing device that is coupled for communication, such as via a wired or wireless communications medium (e.g., Ethernet, serial, USB, Bluetooth™ or WiFi) for example, to the laser scanner 20.

The controller 38 may also be coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet(\hat{ }) Protocol), RS-232, ModBus, and the like. Additional systems may also be connected to LAN with the controllers 38 in each of these systems being configured to send and receive data to and from remote computers and other systems. The LAN may be connected to the Internet. This connection allows controller 38 to communicate with one or more remote computers connected to the Internet.

The processors 122 are coupled to memory 124. The memory 124 may include random access memory (RAM) device 140, a non-volatile memory (NVM) device 142, and a read-only memory (ROM) device 144. In addition, the processors 122 may be connected to one or more input/output (I/O) controllers 146 and a communications circuit 148. In an embodiment, the communications circuit 148 provides an interface that allows wireless or wired communication with one or more external devices or networks, such as the LAN discussed above.

Controller 38 includes operation control methods embodied in application code. These methods are embodied in computer instructions written to be executed by processors 122, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C #, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while some embodiments herein describe a point cloud that is generated by a TOF scanner, this is for example purposes and the claims should not be so limited. In other embodiments, the point cloud may be generated or created using other types of scanners, such as but not limited to triangulation scanners, area scanners, structured-light scanners, laser line scanners, flying dot scanners, and photogrammetry devices for example.

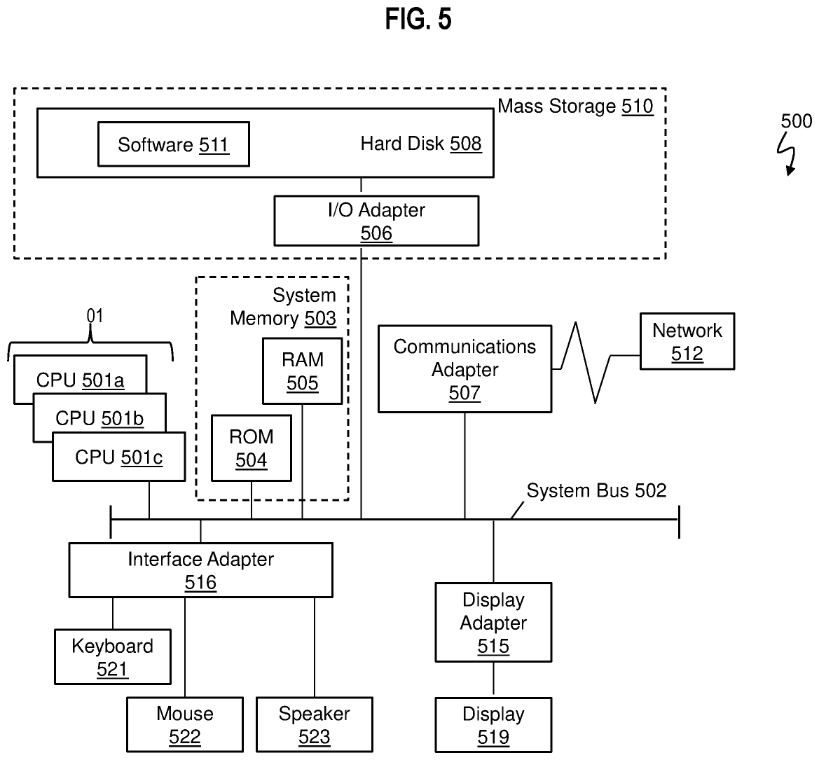

Turning now to FIG. 5, a computer system 500 is generally shown in accordance with one or more embodiments described herein. The computer system 500 can be an electronic, computer framework comprising and/or employing any number and combination of computing devices and networks utilizing various communication technologies, as described herein. The computer system 500 can be easily scalable, extensible, and modular, with the ability to change to different services or reconfigure some features independently of others. The computer system 500 can be, for example, a server, desktop computer, laptop computer, tablet computer, or smartphone. In some examples, computer system 500 can be a cloud computing node. Computer system 500 can be described in the general context of computer system executable instructions, such as program modules, being executed by a computer system. Generally, program modules can include routines, programs, objects, components, logic, data structures, and so on that perform particular tasks or implement particular abstract data types. Computer system 500 can be practiced in distributed cloud computing environments where tasks are performed by remote processing devices that are linked through a communications network. In a distributed cloud computing environment, program modules can be located in both local and remote computer system storage media including memory storage devices.

As shown in FIG. 5, the computer system 500 has one or more central processing units (CPU(s)) 501a, 501b, 501c, etc., (collectively or generically referred to as processor(s) 501). The processors 501 can be a single-core processor, multi-core processor, computing cluster, or any number of other configurations. The processors 501, also referred to as processing circuits, are coupled via a system bus 502 to a system memory 503 and various other components. The system memory 503 can include a read only memory (ROM) 504 and a random access memory (RAM) 505. The ROM 504 is coupled to the system bus 502 and can include a basic input/output system (BIOS) or its successors like Unified Extensible Firmware Interface (UEFI), which controls certain basic functions of the computer system 500. The RAM is read-write memory coupled to the system bus 502 for use by the processors 501. The system memory 503 provides temporary memory space for operations of said instructions during operation. The system memory 503 can include random access memory (RAM), read only memory, flash memory, or any other suitable memory systems.

The computer system 500 comprises an input/output (I/O) adapter 506 and a communications adapter 507 coupled to the system bus 502. The I/O adapter 506 can be a small computer system interface (SCSI) adapter that communicates with a hard disk 508 and/or any other similar component. The I/O adapter 506 and the hard disk 508 are collectively referred to herein as a mass storage 510.

Software 511 for execution on the computer system 500 can be stored in the mass storage 510. The mass storage 510 is an example of a tangible storage medium readable by the processors 501, where the software 511 is stored as instructions for execution by the processors 501 to cause the computer system 500 to operate, such as is described herein below with respect to the various Figures. Examples of computer program product and the execution of such instruction is discussed herein in more detail. The communications adapter 507 interconnects the system bus 502 with a network 512, which can be an outside network, enabling the computer system 500 to communicate with other such systems. In one embodiment, a portion of the system memory 503 and the mass storage 510 collectively store an operating system, which can be any appropriate operating system to coordinate the functions of the various components shown in FIG. 5.

Additional input/output devices are shown as connected to the system bus 502 via a display adapter 515 and an interface adapter 516. In one embodiment, the adapters 506, 507, 515, and 516 can be connected to one or more I/O buses that are connected to the system bus 502 via an intermediate bus bridge (not shown). A display 519 (e.g., a screen or a display monitor) is connected to the system bus 502 by the display adapter 515, which can include a graphics controller to improve the performance of graphics intensive applications and a video controller. A keyboard 521, a mouse 522, a speaker 523, etc., can be interconnected to the system bus 502 via the interface adapter 516, which can include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 5, the computer system 500 includes processing capability in the form of the processors 501, storage capability including the system memory 503 and the mass storage 510, input means such as the keyboard 521 and the mouse 522, and output capability including the speaker 523 and the display 519.

In some embodiments, the communications adapter 507 can transmit data using any suitable interface or protocol, such as the internet small computer system interface, among others. The network 512 can be a cellular network, a radio network, a wide area network (WAN), a local area network (LAN), or the Internet, among others. An external computing device can connect to the computer system 500 through the network 512. In some examples, an external computing device can be an external webserver or a cloud computing node.

It is to be understood that the block diagram of FIG. 5 is not intended to indicate that the computer system 500 is to include all of the components shown in FIG. 5. Rather, the computer system 500 can include any appropriate fewer or additional components not illustrated in FIG. 5 (e.g., additional memory components, embedded controllers, modules, additional network interfaces, etc.). Further, the embodiments described herein with respect to computer system 500 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

FIG. 6 is a block diagram of a system 600 for reality capture using cloud based computer networks, with automatic setup and capture by one or more devices according to one or more embodiments. Elements of computer system 500 may be used in and/or integrated in computer system 602. Software applications 604 may be implemented as software 511 executed on one or more processors 501, as discussed in FIG. 5.

As stored in advance, data in device settings databases 692 in memory 608 can include the operational settings (including variables) for each type of image capturing device including the laser scanner 20, 3D scanner 670, 2D camera 680, drones 1020, handheld scanners, etc. In one or more embodiments, software application 604 can be employed by a user for creating a new project using a user interface such as, for example, a keyboard, mouse, touch screen, stylus, etc. Software application 604 can include and/or work with a graphical user interface (GUI) 605, and features of the software application 604 can communicate with various application programming interfaces (APIs) 606, where at least one respective API 606 is configured with procedures and syntax to communicate with a respective imaging capture device, including the laser scanner 20, the drones 1020 (including their respective 3D scanners 670 and 2D cameras 680), a handheld scanner, etc. Each of the imaging capture devices including the laser scanner 20, the drones 1020 (including their respective 3D scanners 670 and 2D cameras 680), and handheld devices has respective APIs (not shown) for communicating in the syntax and procedures with their counterpart API in the APIs 606. An API is a set of subroutine definitions, communication protocols, and tools for software, which allow two software programs (or two machines) to communicate with each other. Accordingly, the APIs 606 of computer system 602 can communicate with the laser scanner 20, the drones 1020, and the handheld scanners via their respective APIs (not shown) to instruct, set, and/or cause changes to settings/parameters in the laser scanner 20, drones 1020, and handheld scanners.

The software application 604 is configured to identify one or more device settings in the device settings databases 692 based on user input from a user and then select values (e.g., prestored values) of the device settings to fulfill the requirements of the user inputs. This allows the user to enter objectives and requirements of a new project (which may be to capture internal images of an object and/or external images of the object) and then allows the software application 604 to determine the method and at least one or more device settings for the image capture devices. In one or more embodiments, the software application 604 can include features of, be representative of, and/or be implemented in FARO® Sphere software, FARO® Zone 2D Software, FARO® Zone 3D Software, FARO® PhotoCore Software, and/or FARO® Scene Software, all of which are provided by FARO® Technologies, Inc. Software application 604 can call and/or include the features and functionality of APIs 606. Software application 604 can call and/or use natural language processing NLP algorithms 610 when interfacing with the user through the GUI 605. The NLP algorithms 610 have been trained on historical data for creating new projects for image capture of objects and causing imaging capture devices to capture the object based on at least one device setting that has been set to fulfill the objectives and requirements of the user input 608 for the project. Software application 604 can use, call, and/or be integrated with rules-based algorithms 607 and/or machine learning algorithms 609 for making decisions about which method of capture to suggest and device settings to select for image capture devices according to the objectives and requirements in the user input 608 for the project. An example of a rules-based system is the domain-specific expert system that uses rules to make deductions or choices. The rules-based system includes a set of facts or source of data related to capturing objects, and a set of rules for manipulating that data. These rules are sometimes referred to as “If statements” as they tend to follow the line of “IF X happens THEN do Y.” The machine learning algorithms 609 can be trained for pattern recognition based on historical data of past user input 608 and their corresponding suggestions/options in order to learn how to classify/output the suggestions/options for the users. Accordingly, the software application 604 provides options for capturing the object of the project according to user input 608 of objectives and requirements related to the object.

In one or more embodiments, the machine learning model 609 can include various engines/classifiers and/or can be implemented on a neural network. The features of the engines/classifiers can be implemented by configuring and arranging the computer system 602 to execute machine learning algorithms. In general, machine learning algorithms, in effect, extract features from received data (e.g., the user inputs 608 for the object) in order to “classify” the received data. Examples of suitable classifiers include but are not limited to neural networks, support vector machines (SVMs), logistic regression, decision trees, hidden Markov Models (HMIs), etc. The end result of the classifier's operations, i.e., the “classification,” is to predict a class for the data. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In one or more embodiments the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Training datasets can be utilized to train the machine learning algorithms 609. The training datasets can include historical data of past user inputs 608 and their corresponding options/suggestions provided for the respective user inputs. Labels of options/suggestions can be applied to respective user inputs 608 to train the machine learning algorithms, as part of supervised learning. For the preprocessing, the raw training datasets may be collected and sorted manually. The sorted dataset may be labeled (e.g., using the Amazon Web Services® (AWS®) labeling tool such as Amazon SageMaker® Ground Truth). The training dataset may be divided into training, testing, and validation datasets. Training and validation datasets are used for training and evaluation, while the testing dataset is used after training to test the machine learning model on an unseen dataset. The training dataset may be processed through different data augmentation techniques. Training takes the labeled datasets, base networks, loss functions, and hyperparameters. Once these are all created and compiled, the training of the neural network occurs to eventually result in the trained machine learning model (e.g., trained machine learning algorithms). Once the model is trained, the model (including the adjusted weights) is saved to a file for deployment and/or further testing on the test dataset.

The various components, modules, engines, etc., described regarding the computer system 602 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the computer system 602 for executing those instructions. Thus, a system memory (e.g., the memory 608) can store program instructions that when executed by the computer system 602 implement the engines described herein. Other engines can also be utilized to include other features and functionality described in other examples herein.

A network adapter (not shown) provides for the computer system 602 to transmit data to and/or receive data from other sources, such as other processing systems, data repositories, and the like. As an example, the computer system 602 can transmit data to and/or receive data from the camera 680, the scanner 670, and/or a user device 660 directly and/or via a network 650.

The network 650 represents any one or a combination of different types of suitable communications networks such as, for example, cable networks, public networks (e.g., the Internet), private networks, wireless networks, cellular networks, or any other suitable private and/or public networks. Further, the network 650 can have any suitable communication range associated therewith and may include, for example, global networks (e.g., the Internet), metropolitan area networks (MANs), wide area networks (WANs), local area networks (LANs), or personal area networks (PANs). In addition, the network 650 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The camera 680 can be a 2D camera or a 3D camera (RGBD or time-of-flight for example). The camera 680 captures an image (or multiple images), such as of an environment 160. The camera 680 transmits the images to the computer system 602. In one or more embodiments, the camera 680 encrypts the image before transmitting it to the computer system 602. Although not shown, the camera 680 can include components such as a processing device, a memory, a network adapter, and the like, which may be functionally similar to those included in the computer system 500, 602 as described herein.

In some examples, the camera 680 is mounted to a mobile base, which can be moved about the environment 160. In some examples, the camera 680 is disposed in or mounted to an unmanned aerial vehicle. In various examples, the camera 680 is mounted on a manned aerial vehicle and/or unmanned aerial vehicle, generally referred to as a drone. In some examples, the camera 680 is mounted to a fixture, which is user-configurable to rotate about a roll axis, a pan axis, and a tilt axis. In such examples, the camera 680 is mounted to the fixture to rotate about the roll axis, the pan axis, and the tilt axis. Other configurations of mounting options for the camera 680 also are possible.

A coordinate measurement device, such as scanner 670 for example, is any suitable device for measuring 3D coordinates or points in an environment, such as the environment 160, to generate data about the environment. The scanner 670 may be implemented as a TOF laser scanner 20. A collection of 3D coordinate points is sometimes referred to as a point cloud. According to one or more embodiments described herein, the scanner 670 is a three-dimensional (3D) laser scanner time-of-flight (TOF) coordinate measurement device. It should be appreciated that while embodiments herein may refer to a laser scanner, this is for example purposes and the claims should not be so limited. In other embodiments, other types of coordinate measurement devices or combinations of coordinate measurement devices may be used, such as but not limited to triangulation scanners, structured light scanners, laser line probes, photogrammetry devices, and the like. A 3D TOF laser scanner steers a beam of light to a non-cooperative target such as a diffusely scattering surface of an object. A distance meter in the scanner 670 measures a distance to the object, and angular encoders measure the angles of rotation of two axles in the device. The measured distance and two angles enable a processor in the scanner 670 to determine the 3D coordinates of the target.

A TOF laser scanner, such as the scanner 670, is a scanner in which the distance to a target point is determined based on the speed of light in air between the scanner and a target point. Laser scanners are typically used for scanning closed or open spaces such as interior areas of buildings, industrial installations, and tunnels. They may be used, for example, in industrial applications and accident reconstruction applications. A laser scanner, such as the scanner 670, optically scans and measures objects in a volume around the scanner 670 through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected and stored as a point cloud, which can be transmitted to the computer system 602 and stored in the database 690 about the environment 160.

In some examples, the scanner 670 is mounted to a mobile base, which can be moved about the environment 160. In some examples, the scanner 670 is disposed in or mounted to an unmanned aerial vehicle. In various examples, the scanner 670 is mounted on a manned aerial vehicle and/or unmanned aerial vehicle, generally referred to as a drone. In some examples, the scanner 670 is mounted to a fixture, which is user-configurable to rotate about a roll axis, a pan axis, and a tilt axis. In such examples, the scanner 670 is mounted to the fixture to rotate about the roll axis, the pan axis, and the tilt axis. Other configurations of mounting options for the scanner 670 also are possible.

According to one or more embodiments described herein, the camera 680 captures 2D image(s) of the environment 160 and the scanner 670 captures 3D information of the environment 160. In some examples, the camera 680 and the scanner 670 are separate devices; however, in some examples, the camera 680 and the scanner 670 are integrated into a single device. For example, the camera 680 can include depth acquisition functionality and/or can be used in combination with a 3D acquisition depth camera, such as a time of flight camera, a stereo camera, a triangulation scanner, LIDAR, and the like. In some examples, 3D information can be measured/acquired/captured using a projected light pattern and a second camera (or the camera 680) using triangulation techniques for performing depth determinations. In some examples, a time-of-flight (TOF) approach can be used to enable intensity information (2D) and depth information (3D) to be acquired/captured. The camera 680 can be a stereo-camera to facilitate 3D acquisition. In some examples, a 2D image and 3D information (i.e., a 3D data set) can be captured/acquired at the same time; however, the 2D image and the 3D information can be obtained at different times.

The user device 660 (e.g., a smartphone, a laptop or desktop computer, a tablet computer, a wearable computing device, a smart display, and the like) can also be located within or proximate to the environment 160. The user device 660 can display an image of the environment 160, such as on a display of the user device 660 (e.g., the display 519 of the computer system 500 of FIG. 5) along with a digital visual element. In some examples, the user device 660 can include components such as a processor, a memory, an input device (e.g., a touchscreen, a mouse, a microphone, etc.), an output device (e.g., a display, a speaker, etc.), and the like.

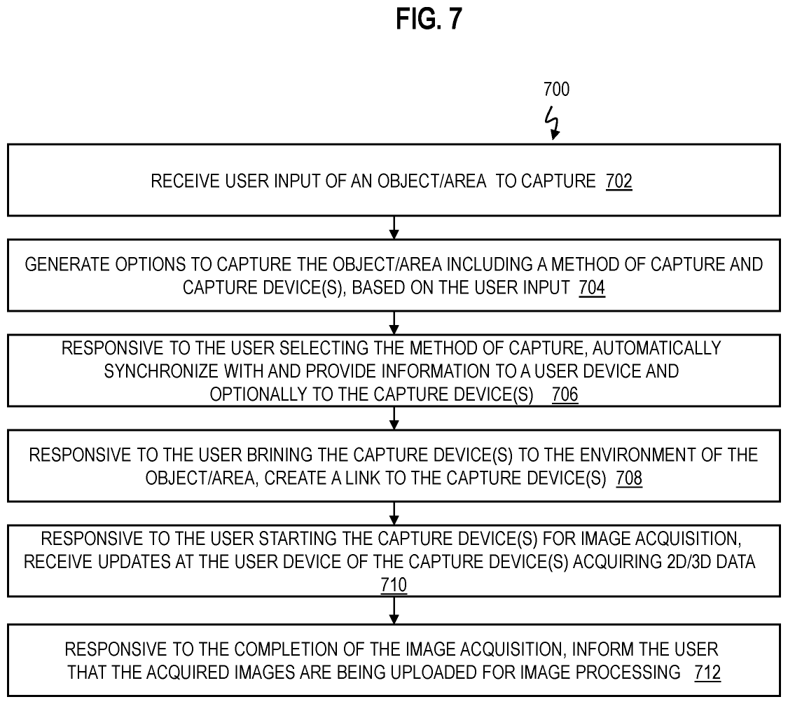

For ease of understanding and not limitation, an example scenario is illustrated using drones and a laser scanner to assist a user with an image capture project for an object. It should be appreciated that embodiments are not limited to the example scenario and other environments may be used. In the example scenario, a building may be referred to as the object, but it should be appreciated that objects are not limited to a building. FIG. 7 depicts a flowchart 700 for reality capture using cloud based computer networks with automatic setup and capture by imaging capture devices according to one or more embodiments. A drone, such an unmanned or manned aerial vehicle, may include the camera 680 to capture images of a physical location which can be the environment 160. The physical location can be of an object which may be an area, a structure (such as a building), and/or both a structure and area. Numerous images (e.g., typically several hundred images) may be captured and stored as data in database 690 in computer system 602. Similarly, large amounts of scan data can be captured by the laser scanner 20 and stored in the database 690 for further processing.

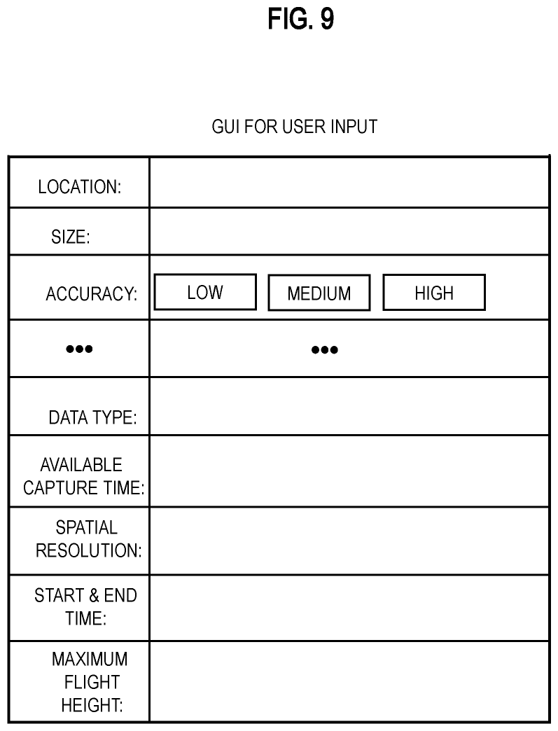

At block 702, the software application 604 is configured to receive user input 608 for an object to be imaged. As noted above, the object can be an area, a structure, and/or both an area and structure. Using the GUI 605 of the software application 604, the user may create a new project to capture images for the object. The user input 608 can include the location and size of the project (e.g., the whole building, X (30,000) square feet (sq. ft.), inside and outside of the building, etc.). In one embodiments, the user may select the object by marking on a Google® maps display of a certain building. In the user input 608, the user also sets the required accuracy and whether pictures (2D images), 3D images, and/or both are requested. In the user input 608, the location input by the user can include an address, a selection in an Internet hosted mapping system (e.g., Google® maps), waypoints which may include latitude and longitude coordinates, etc. The user can create a generate a general data lake or geofence around the object to be captured and can provide location information using an Internet hosted mapping system (e.g., Google® maps), geo databases, land registry data, land plots, parcels, etc. The user input 608 can include the main purpose of the capture, for example, for building information modeling (BIM). Also, the user input 608 can include the data type required for capturing the object, such as, for example, 2D images (i.e., pictures), 360° spherical images (e.g., panoramic images for panoramic viewing), 3D data points (for 3D point cloud generation), 3D data points plus 2D images, and/or any combination of the above. The user input 608 can include accuracy requirements about georeferencing and local accuracy. In one or more embodiments, the user input can include specifications (or resolution) of the desired accuracy for capturing the object. In addition to allowing the user to specific the desire accuracy or resolution, the GUI 605 may provide preset accuracy categories for capturing the object, such that the user can select from a low accuracy/resolution, medium accuracy/resolution, and high accuracy/resolution. FIG. 9 is an example of a GUI for receiving the user input 608 of a project according to one or more embodiments.

At block 704, the software application 604 is configured generate one or more options to capture the object including one or more methods of capture and the corresponding image capture devices used for each method of capture. The software application 604 may include, use, and/or call one or more rules-based algorithms 607 and/or machine learning algorithms 609 for processing the user input 608 in order to suggest image capture options for the object. The software application 604 is configured to start with all the image capture devices that are available for use and then eliminate any image capture devices that fail to meet the requirements in the user input. For each entry of the user input 608, the software application 604 is configured to create a matrix of each image capture device that can fulfill the requirements for capturing the object, such as the requirements in the user input 608 for location, size, accuracy, data type, time, etc. One or more image capture devices may be eliminated from the matrix when the software application 604 determines that the particular image capture device cannot meet one of the requirements of the user input 608. In some cases, when a change in one of the requirements of the user input 608 could increase the user's options for available image capture devices, the software application 604 is configured to inquire of the user about making a change to his/her previous entry so that at least one additional image capture device (e.g., drones) can be included in the options. If the user agrees to changing the requirement that allows at least one additional image capture device to be added as an option, the software application 604 is configured to present the additional image capture devices along with other image capture devices as options for capturing the object. In one or more embodiments, the software application 604 may call, be integrated with, and/or use the rules-based algorithms make inquiries to the user and correspondingly provide answers to the user. In one or more embodiments, the software application 604 may call, be integrated with, and/or use NLP algorithms 610 to assist with making inquiries to the user and providing answers to the user.

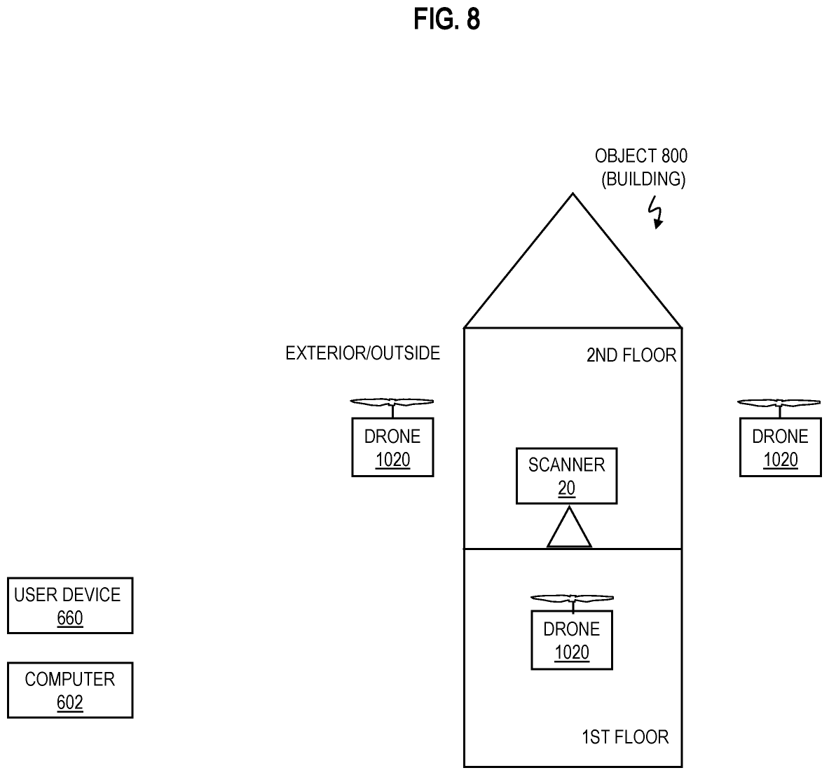

In some cases, there may be an object that can have different imaging requirements for different portions of the object, where some portions of the object can have, for example, less accuracy or less resolution than other portions of the object that require high accuracy or high resolution. For example, the object may be a building 800 with two floors, as depicted in the block diagram of FIG. 8. While receiving the user information as the user input 608, the software application 604 is configured to ask is the object a structure. The software application 604 may employ the rules-based algorithms 607 and/or the NLP algorithms 610 to make the inquiry and process the response received from the user. When the user indicates that the object is a building that has different image capture requirements for at least two portions of the building, the software application 604 is configured to request and receive user input 608 for each portion of the building, so that the software application 604 can generate a matrix of options for each separate portion of the building 800 that has been identified by the user. The software application 604 may ask how many different portions there are of the object (i.e., building) and then ask the user to input separate requirements for each portion of the object. In this case, the user building 800 has three portions which are the exterior/outside portion, the 1st floor portion, and the 2nd floor portion, all of which are to be imaged. The software application 604 is configured to determine that the image capture device should be the laser scanner 20 for the 2nd floor of the building 800, and this determination is based in part on the requirement for high accuracy (e.g., high accuracy category) in the user input 608 for the 2nd floor. The software application 604 is configured to determine that the image capture device should be drones 1020 for the 1st floor of the building 800, and this determination is based in part on the requirement for low or medium accuracy (e.g., low or medium accuracy category) in the user input 608 for the 2nd floor and based in part on meeting a time requirement (where the time for scanning with the laser scanner 20 requires more time than what is allowed). Additionally, the software application 604 is configured to determine that the image capture device should be drones 1020 for imaging the exterior/outside portion of the building 800, and this determination is based in part on the requirement for low or medium accuracy (e.g., a low or medium accuracy category) in the user input 608 for the exterior/outside portion and a time requirement. As the options to meet the requirements in the user input 608 for the three portions of the building 800, the software application 604 is configured to recommend or suggest using drones 1020 for the 1st floor, the laser scanner 20 for the 2nd floor, and drones 1020 for the exterior/outside portion as depicted in FIG. 8. It should be appreciated that the building 800 is illustrated as an example of the object to be captured for explanation purposes, and embodiments apply to various types of objects.

Also, there are many ways in which the user may provide his/her user input 608, such that the software application 604 can generate options for capturing the object. For user input 608, the user may input/select a layout plan with 3 centimeter (cm) accuracy with no images; as such, the software application 604 is configured to suggest the option of mobile mapping with a handheld scanning device.

For user input 608, the user may input/select 3D model for robot automation with at least or less (<) 5 millimeter (mm) accuracy global; as such, the software application 604 is configured to suggest the option of terrestrial scans (using, e.g., the laser scanner 20) with a reference system. In one case, the software application 604 may inform the user whether the reference system for this object is already available or required.

There may be a case in which the user provides his/her user input 608, and the software application 604 is configured to inform the user that the user has already capture this object more than one time using 360° images.

For accuracy and distance validation, various techniques can be used as the reference system. An agency capturing aerial images can typically use a scale artifact, such the FARO® scalebar (for NIST traceability) for example. This provides a way to verify distance measurement (of the imaging discussed herein) with a desired level of accuracy because it is based on software measurements and not due to the user's skill or knowledge level. If a scalebar is not present, one can use a known measurement in their scene/environment. Typically, an object of known length (e.g., a yard/meter stick) can be used or a tape measure at a known length can be used in the scene of the captured image. If an object of known measurement is not used, the user can utilize fixed points, such as the lane width or a door width of a vehicle or building. It should be appreciated that the examples of objects of known measurement provided herein are for example purposes and the claims should not be so limited, in other embodiments, there are many options about how many times to use a measurement for accuracy. Some may use the measure just once in a project. Others may use the measurement for accuracy at the first and last scan, while some may use it for each scan.

Referring to FIG. 7 at block 706, in response to the GUI 605 of the software application 604 receiving selection of one of the options by the user, the software application 604 is configured to automatically synchronize with the user device 690 and the imaging/capture devices (e.g., laser scanner 20 and/or drones 1020) via the network 650. The software application 604 can automatically synchronize with a corresponding software application (not shown) on the (mobile) user device 600 and provide all project information/settings along with location information (such as layout plans). Also, the software application 604 is configured to parse the device settings database 692 for the particular image capture devices selected by the user. Continuing the example scenario with the building 800, the user may have input that a photogrammetry method/device is to be used for images captured for the 1st floor and exterior/outside portions of the building 800 and/or the software application 604 can determine that photogrammetry can be utilized for images captured for the 1st floor and exterior/outside portions of the building 800. As such, the software application 604 is configured to parse the setting for drones 1020 in the (drone) device settings database 692 and select settings (e.g., resolution for the 2D camera 680) to accommodate photogrammetry; accordingly, the software application 604 is configured to pass these selected device settings to the (drone) API 606 and then transmit the selected device settings to the drone 1020 via network 650. Similarly, the software application 604 is configured to parse the setting for the laser scanner 20 in the (laser scanner) device settings database 692 and select device settings (e.g., resolution for the laser scanner) to accommodate 3D point clouds; accordingly, the software application 604 is configured to pass these selected device settings to the (laser scanner) API 606 and then transmit the selected device settings to the laser scanner 20 via network 650.

Additionally, using the location of the object to be imaged, the software application 604 is configured to search external databases 696 in servers 694 for rules, ordinances, and government regulations for use of drones. Furthermore, the software application 604 can check (e.g., search and parse) other cloud systems such as government systems (e.g., one or more external servers 694 and databases 696 can be part of a government cloud system) to gather data about local legal restrictions regarding the use of drones. As such, the software application 604 can provide any information regarding local legal restrictions for using drones, which supports decision making of the drone operator about whether a drone capture is applicable or not. For example, there may be a height limitation (e.g., a law or regulation) in the proximity of the object (e.g., building 800) where drones cannot be flown above a certain height X, which is found as result of the search by the software application 604. Accordingly, the software application 604 is configured to input a device setting that the drones 1020 cannot be permitted to fly above the height X when imaging the object (e.g., building 800). As such, the software application 604 is configured to transmit the height X requirement to the drones 1020 with the assistance of the (drone) API 606. In some cases, the software application 604 may provide at least partial instructions/assistance with the flight planning. As understood by one of ordinary skill in the art, drones may include their own automated guidance and control system. Drones are configured to fly using GPS data and to collect LIDAR data for autonomous flight. Using LIDAR data, drones can perform auto position hold, prevent collisions by finding a route around obstacles, and operate with LIDAR-powered obstacle avoidance. An example of such a drone may include features of the Dronut® X1 by Cleo Robotics.

Referring to FIG. 7 at block 708, in response to the user bringing the imaging/capture devices (e.g., drones 1020 and laser scanner 20) to the environment 160 of the object, the software application 604 is configured to create a link (e.g., via the network 650) with the image capture devices (e.g., drones 1020 and laser scanner 20) to upload any device setting information that may not have been previously sent. In one or more embodiments, the user device 660 can be utilized to transmit the information to the image capture devices.

In one example, there can be a transport box with multiple drones inside, a charging station, and wireless (5G) and/or wired connectivity to the software application 604 and/or to the user device 660. The user brings the transport box in front of the object to be captured and opens the transport box. The transport box creates a link to the software application on the user device 660 of the user and/or directly to the Internet to download required information for the job from the software application 604. Such information may include flight rights and path planning according to available layout plans and environment information. The drone path planning may be based on the user input 608 of required resolution and the area to be captured. The user presses a start button, and the drone swarm starts to do the job and capture the scene autonomously. If required, drones fly back to the transport box to be recharged. The drones can use known swarm technology to individually perform their respective jobs.

Also, the software application 604 may instruct the user to place the laser scanner 20 at a certain location near or in the object to be scanned, for example, the software application 604 may instruct the user to place the laser scanner 20 at or near the center of the 2nd floor in the building 800. The software application 604 can give additional instructions when obstacles are present, such as to take scans on both sides of the obstacles. The user presses the start button, and the laser scanner 20 performs its scans.

Referring to FIG. 7 at block 710, in response to the user starting the image capture devices (e.g., drones 1020 and laser scanner 20), the user device 660 and/or software application 604 are configured to receive updates of the image capture devices acquiring images. The image capture devices can be for 2D and/or 3D capture, where 3D sensors are utilized. For example, the user is updated about the capture progress in real-time with a low resolution that grows to a 2D model and/or 3D model, like a radar. Once the scanning or imaging operation is done, the drones 1020 are configured to fly back to the transport box, and the laser scanner 20 may be configured to power down.

At block 712, in response to completion of the image acquisition, the software application 604 and/or user device 660 are configured to inform the user that the acquired images are being uploaded to the software application 604 for image processing. In one or more embodiments, the software application 604 is configured to suggest placement of an artificial target as the reference system (e.g., a yardstick) in order to combine the laser scanner and drone data.

The software application 604 is configured to perform, use, and/or call on software to perform registration to merge the 3D point data from various scans acquired by the laser scanner 20. Known techniques for generating a 3D point cloud from the 3D point data (3D image) may be utilized. A 3D image of a scene may require multiple scans from different registration positions, and the overlapping scans are registered in a joint coordinate system, for example, as described in U.S. Published Patent Application No. 2012/0069352 ('352), the contents of which are incorporated herein by reference. Such registration is performed by matching targets in overlapping regions of the multiple scans. The targets may be artificial targets such as spheres or checkerboards or they may be natural features such as corners or edges of walls. Some registration procedures involve relatively time-consuming manual procedures such as identifying by a user each target and matching the targets obtained by the scanner in each of the different registration positions.

The software application 604 is configured call, use, and/or communicate with photogrammetry software to perform photogrammetric processing or photogrammetry on the images acquired by the drones 1020. Photogrammetry is a technique to obtain reliable data of real-world objects in the environment by creating 3D models from photos. Digital image capturing and photogrammetric processing includes several well defined stages, which allow the generation of 2D or 3D digital models of the object as an end product, as obtained by software application 604 at block 706. Photogrammetry may include the following: feature detection in the images, feature matching between images, estimation of position and orientation for each image in 3D space, bundle adjustment to fine tune the position and orientation, and output of a 3D point cloud of the environment 160.

Further, photogrammetry is a technique for measuring objects using images, such as photographic images acquired by a digital camera for example. Photogrammetry can make 3D measurements from 2D images or photographs. When two or more images are acquired at different positions that have an overlapping field of view, common points or features may be identified on each image. By projecting a ray from the camera location to the feature/point on the object, the 3D coordinate of the feature/point may be determined using trigonometry or triangulation. In some examples, photogrammetry may be based on markers/targets (e.g., lights or reflective stickers) or based on natural features. To perform photogrammetry, for example, images are captured, such as with a camera having a sensor, such as a photosensitive array for example. By acquiring multiple images of an object, or a portion of the object, from different positions or orientations, 3D coordinates of points on the object may be determined based on common features or points and information on the position and orientation of the camera when each image was acquired. In order to obtain the desired information for determining 3D coordinates, the features are identified in two or more images. Since the images are acquired from different positions or orientations, the common features are located in overlapping areas of the field of view of the images. It should be appreciated that photogrammetry techniques are described in commonly-owned U.S. Pat. No. 10,597,753, the contents of which are incorporated by reference herein. With photogrammetry, two or more images are captured and used to determine 3D coordinates of features.

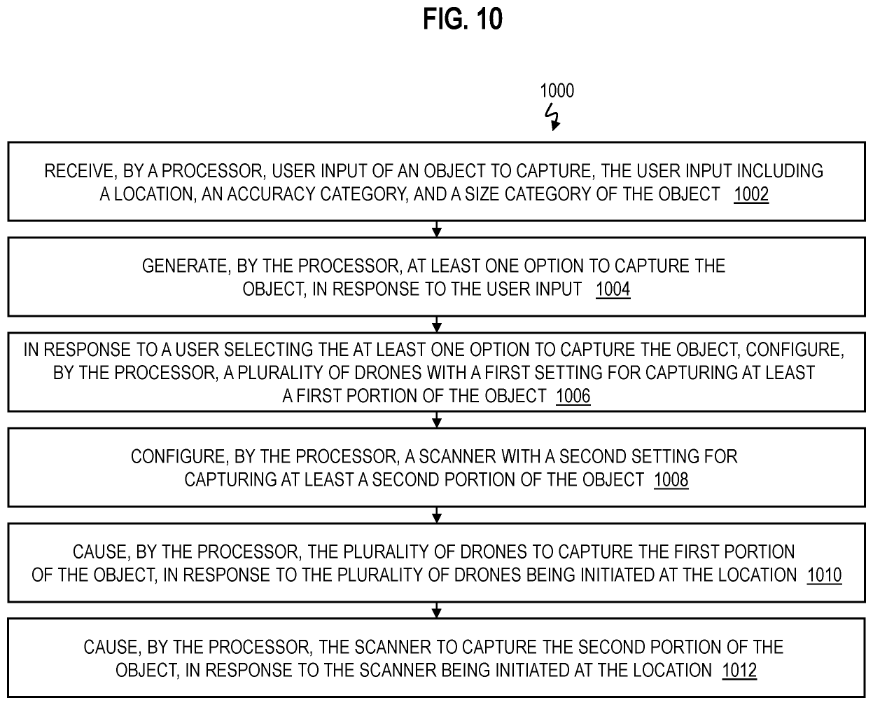

FIG. 10 depicts a flowchart of a computer-implemented method 1000 for reality capture using cloud based computer networks according to one or more embodiments described herein. The computer-implemented method 1000 can be performed by or implemented on any suitable processing system, for example, the computer system 602 in FIG. 6, a cloud computing node, and/or combinations thereof.

At block 1002 of the computer-implemented method 1000, the software application 604 is configured to receive user input 608 of an object to capture, the user input 608 including a location, an accuracy category, and a size category of the object. At block 1004, the software application 604 is configured to generate at least one option or suggestion to capture the object, in response to the user input 608. The software application 604 is configured to generate the options for display to the user on a display. At block 1006, the software application 604 is configured to, responsive to a user selecting the at least one option to capture the object, configure a plurality of drones 1020 with a first setting for capturing at least a first portion of the object (e.g., the 1st floor and/or exterior of the building 800). The software application 604 may parse (drone) device setting in the device settings database 692 to obtain the desired setting. At block 1008, the software application 604 is configured to configure a scanner (e.g., laser scanner 20) with a second setting for capturing at least a second portion of the object (e.g., the 2nd floor of the building 800), in response to the user selecting the at least one option to capture the object. The software application 604 may parse (laser scanner) device setting in the device settings database 692 to obtain the desired setting. At block 1010, the software application 604 is configured to cause the plurality of drones 1020 to capture the first portion of the object (e.g., the exterior portion and/or the 1st floor of the building 800), in response to the plurality of drones being initiated at the location. At block 1012, the software application 604 is configured to cause the scanner (e.g., laser scanner 20) to capture the second portion of the object (e.g., the 2nd floor of the building 800), in response to the scanner being initiated at the location.

Further, generating the at least one option to capture the object comprises suggesting the plurality of drones (or a handheld scanner) based in part on the accuracy category associated with the first portion of the object. Generating the at least one option to capture the object comprises suggesting the plurality of drones based in part on a time requirement. Generating the at least one option to capture the object comprises suggesting the scanner based in part on the accuracy requirement associated with the second portion of the object. The software application 604 is configured to display the suggestions as options in the GUI.

Further, the software application 604 is configured to parse one or more databases to obtain specifications or requirements associated with the location of the object. For example, the software application 604 is configured to parse one or more external databases 696 of one or more external servers 694 to obtain/retrieve specifications and requirements associated with the location of the object. In the first settings, the software application 604 is configured to restrict a height for flying the plurality of drones 1020 based on the specification or the requirements obtained from the one or more databases.

Additionally, in the first settings, the software application 604 is configured to cause the plurality of drones 102 to update a user device 660 of the user (and/or the software application 604) during a time of the plurality of drones capturing the first portion of the object. Coverage (for the 2D and/or 3D images taken) of the first portion of the object overlaps coverage (for the 2D and/or 3D images) of the second portion of the object, such that registration is operable for outputs of the plurality of drones 1020 and the scanner (e.g., laser scanner 20).

The software application 604 is configured to receive a first output from the plurality of drones 1020 and a second output from the scanner (e.g., laser scanner 20) via one or more communication links (e.g., network 650). The software application 604 is configured to provide an approximate time of completion for capturing the object using the at least one option.

While embodiments of the invention have been described in detail in connection with only a limited number of embodiments, it should be readily understood that embodiments of the invention are not limited to such disclosed embodiments. Rather, embodiments of the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, embodiments of the invention are not to be seen as limited by the foregoing description, but is only limited by the scope of the appended claims.

What is claimed is:

1. A computer-implemented method comprising:
receiving, by a processor, a user input of an object to capture, the user input including a location, an accuracy category, and a size category of the object;
generating, by the processor, at least one option to capture the object, in response to the user input;
in response to a user selecting the at least one option to capture the object, configuring, by the processor, a plurality of drones with a first setting for capturing at least a first portion of the object;
configuring, by the processor, a scanner with a second setting for capturing at least a second portion of the object;
causing, by the processor, the plurality of drones to capture the first portion of the object, in response to the plurality of drones being initiated at the location; and
causing, by the processor, the scanner to capture the second portion of the object, in response to the scanner being initiated at the location.

2. The computer-implemented method of claim 1, wherein generating the at least one option to capture the object comprises suggesting the plurality of drones or a handheld scanner based in part on the accuracy category associated with the first portion of the object.

3. The computer-implemented method of claim 1, wherein generating the at least one option to capture the object comprises suggesting the plurality of drones based in part on a time requirement.

4. The computer-implemented method of claim 1, wherein generating the at least one option to capture the object comprises suggesting the scanner based in part on the accuracy category associated with the second portion of the object.

5. The computer-implemented method of claim 1, further comprising parsing one or more databases to obtain specifications or requirements associated with the location of the object.

6. The computer-implemented method of claim 5, wherein, in the first setting, restricting a height for flying the plurality of drones based on the specifications or the requirements obtained from the one or more databases.

7. The computer-implemented method of claim 1, wherein, in the first setting, causing the plurality of drones to update a user device of the user during a time of the plurality of drones capturing the first portion of the object.

8. The computer-implemented method of claim 1, wherein coverage of the first portion of the object overlaps coverage of the second portion of the object, such that registration is operable for outputs of the plurality of drones and the scanner.

9. The computer-implemented method of claim 1, further comprising receiving a first output from the plurality of drones and a second output from the scanner via one or more communication links.

10. The computer-implemented method of claim 1, further comprising providing an approximate time of completion for capturing the object using the at least one option.

11. A system comprising:
a memory having computer readable instructions; and
one or more processors for executing the computer readable instructions, the computer readable instructions controlling the one or more processors to perform operations comprising:
receiving a user input of an object to capture, the user input including a location, an accuracy category, and a size category of the object;
generating at least one option to capture the object, in response to the user input;
in response to a user selecting the at least one option to capture the object, configuring a plurality of drones with a first setting for capturing at least a first portion of the object;
configuring a scanner with a second setting for capturing at least a second portion of the object;
causing the plurality of drones to capture the first portion of the object, in response to the plurality of drones being initiated at the location; and
causing the scanner to capture the second portion of the object, in response to the scanner being initiated at the location.

12. The system of claim 11, wherein generating the at least one option to capture the object comprises suggesting the plurality of drones or a handheld scanner based in part on the accuracy category associated with the first portion of the object.

13. The system of claim 11, wherein generating the at least one option to capture the object comprises suggesting the plurality of drones based in part on a time requirement.

14. The system of claim 11, wherein generating the at least one option to capture the object comprises suggesting the scanner based in part on the accuracy category associated with the second portion of the object.

15. The system of claim 11, wherein the one or more processors are configured to parse one or more databases to obtain specifications or requirements associated with the location of the object.

16. The system of claim 15, wherein, in the first setting, the one or more processors are configured to restrict a height for flying the plurality of drones based on the specifications or the requirements obtained from the one or more databases.

17. The system of claim 11, wherein, in the first setting, the one or more processors are configured to cause the plurality of drones to update a user device of the user during a time of the plurality of drones capturing the first portion of the object.

18. The system of claim 11, wherein coverage of the first portion of the object overlaps coverage of the second portion of the object, such that registration is operable for outputs of the plurality of drones and the scanner.

19. The system of claim 11, wherein the one or more processors are configured to receive a first output from the plurality of drones and a second output from the scanner via one or more communication links.

20. The system of claim 11, wherein the one or more processors are configured to provide an approximate time of completion for capturing the object using the at least one option.
